(19) United States
(12) Patent Application Publication
(10) Pub. No.: US 2011/0115459 A1
(43) Pub. Date: May 19, 2011

(54) PHASE ADJUSTING SYSTEM AND METHOD

(75) Inventors: CHIH-SHENG HSIEH, Tu-Cheng (TW); LI-CHUNG SUN, Tu-Cheng (TW)

(73) Assignee: HON HAI PRECISION INDUSTRY CO., LTD., Tu-Cheng (TW)

(21) Appl. No.: 12/633,659

(22) Filed: Dec. 8, 2009

(30) Foreign Application Priority Data
Nov. 17, 2009 (CN) 200910309828.4

(51) Int. Cl. G05F 1/565

(52) U.S. Cl. 323/285

(57) ABSTRACT

A phase adjusting system includes a controlled element, a multi-phase pulse-width modulation (PWM) controller comprising default and non-default phases, and a microprogrammed control unit (MCU). The PWM controller provides phases to the controlled element. The MCU is connected to the controlled element via the multi-phase PWM controller. The MCU detects the work voltage level of the controlled element and controls the multi-phase PWM controller to provide a corresponding number of phases to the controlled element. The MCU determines whether work time of the default phases of the multi-phase PWM controller is greater than a predetermined value in response to the MCU being initialized. The default phases are changed to non-default phases and a corresponding number of the plurality of non-default phases are changed to default phases in response to the work time of the plurality of default phases of the multi-phase PWM controller being greater than the predetermined value.

### BACKGROUND

1. Technical Field

The present disclosure relates to adjusting systems and methods and, particularly, to an adjusting system and an adjusting method for adjusting phases of a multi-phase pulse-width modulation (PWM) controller.

2. Description of Related Art

Nowadays, many electronic devices have energy-saving control functions by using multi-phase pulse-width modulation (PWM) controllers. For example, a central processing unit (CPU) of a motherboard may have a light-load work status, a normal-load work status, and an over-load work status. When the CPU works at the light-load work status, a multi-phase PWM controller of the motherboard may provide four phases (namely four PWM signals) to the CPU to control a voltage value provided to the CPU. When the CPU works at the normal-load work status, the multi-phase PWM controller of the motherboard may provide eight phases to the CPU to control the voltage value. When the CPU works at the over-load work status, the multi-phase PWM controller of the motherboard may provide twelve phases of PWM signals to the CPU to control the voltage value. In other words, the more phases provided by the multi-phase PWM controller, the greater voltage value provided to the CPU.

However, an ordinary multi-phase PWM controller may include some default phases and some non-default phases. These default phases are always used in any work status, and the non-default phases are only used for some work statuses. Therefore, the life-spans of the particular parts providing the default phases are less then the life-spans of the particular parts providing the non-default phases, which may reduce the life-span of the multi-phase PWM controller and waste parts providing the non-default phases.

### BRIEF DESCRIPTION OF THE DRAWINGS

FIG. 1 is a block diagram of an exemplary embodiment of a phase adjusting system.

FIG. 2 is a flowchart of an exemplary embodiment of a phase adjusting method.

### DETAILED DESCRIPTION

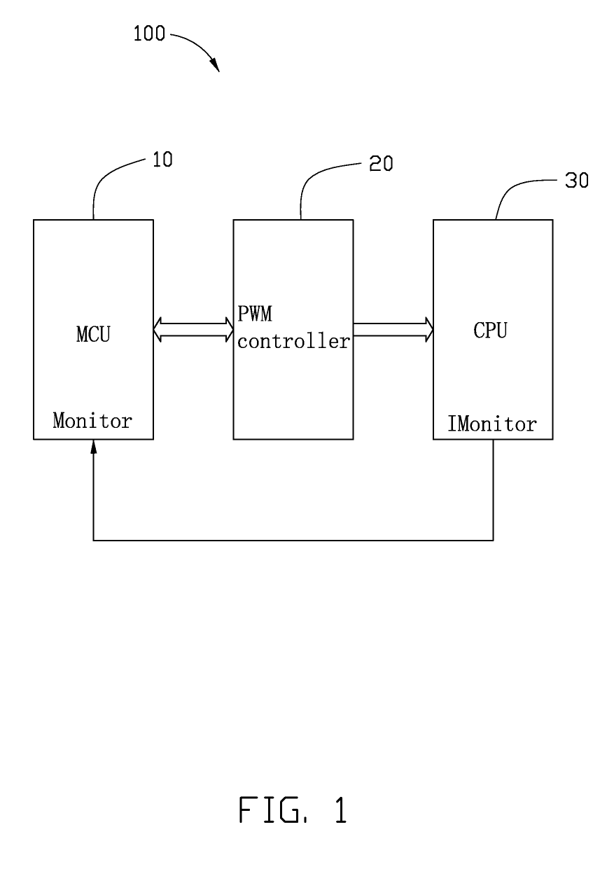

Referring to FIG. 1, an exemplary embodiment of a phase adjusting system 100 includes a microprogrammed control unit (MCU) 10, a multi-phase pulse-width modulation (PWM) controller 20, and a controlled element, such as a central processing unit (CPU) 30. In one embodiment, the MCU 10 is an IT8052NX single-chip. The multi-phase PWM controller 20 is a twelve-phase PWM controller formed by the integration of an IR3502 multi-phase PWM controller and an IR3507 multi-phase PWM controller, and the multi-phase PWM controller 20 can provide twelve phases (namely twelve PWM signals). The number of default phases of the multi-phase PWM controller 20 is four. In other embodiments, the multi-phase PWM controller 20 can be other types, and the number of the default phases of the multi-phase PWM controller 20 also can be changed according to requirements.

The MCU 10 is connected to the CPU 30 via the multi-phase PWM controller 20. A detecting pin Monitor of the MCU 10 is connected to a detecting pin IMonitor of the CPU 30 to receive a voltage sensing signal, which indicates the work voltage level of the CPU 30. The MCU 10 controls the multi-phase PWM controller 20 to provide a corresponding number of phases to the CPU 30 according to the voltage sensing signal, to satisfy a requirement of the work voltage level of the CPU 30.

The MCU 10 also calculates work time of the default phases of the multi-phase PWM controller 20, and determines whether the work time of the default phases of the multi-phase PWM controller 20 is greater than a predetermined value, such as seven days, when the MCU 10 is initialized. When the work time of the default phases of the multi-phase PWM controller 20 is greater than the predetermined value, the MCU 10 controls the multi-phase PWM controller 20 to change the default phases according to a predetermined order, for example change first to fourth phases from default phases to non-default phases and change fifth to eighth phases from non-default phases to default phases. When the work time of the default phases of the multi-phase PWM controller 20 is less than or equal to the predetermined value, the default phases of the multi-phase PWM controller 20 are not changed. According to the above changing operation, the MCU 30 controls the work time of all phases of the multi-phase PWM controller 20 to be approximately equal, which can increase the life-span of the multi-phase PWM controller 20.

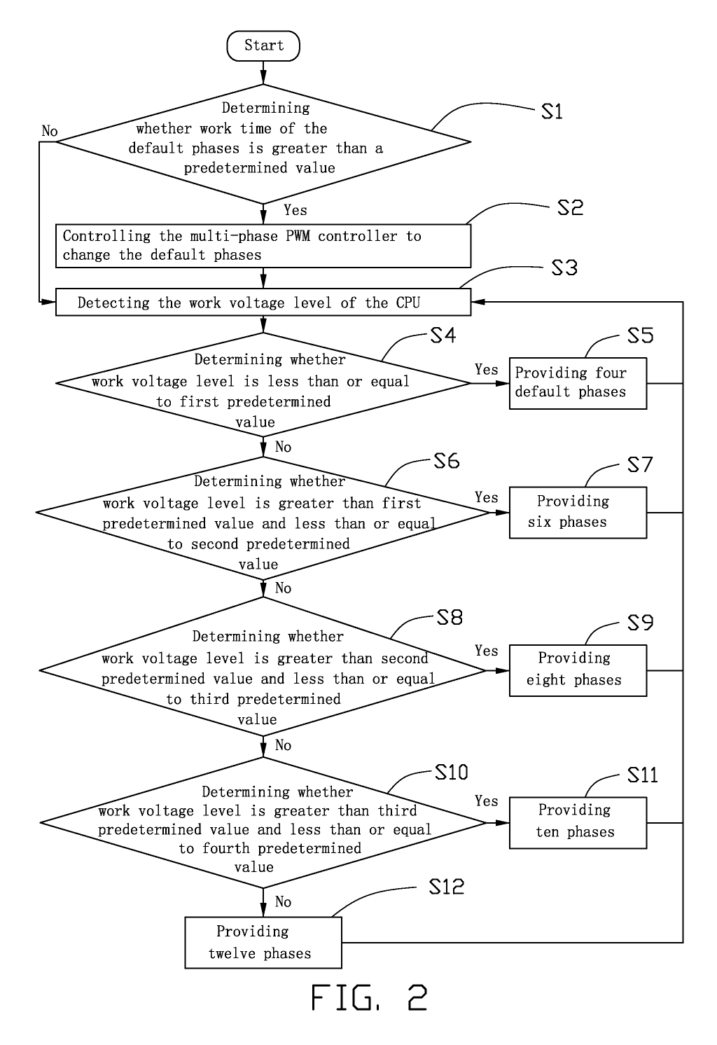

Referring to FIG. 2, an exemplary embodiment of a phase adjusting system 100 includes the following steps.

In step S1, the MCU 10 determines whether work time of the default phases of the multi-phase PWM controller 20 is greater than a predetermined value. If the work time of the default phases of the multi-phase PWM controller 20 is greater than the predetermined value, the process goes to step S2. If the work time of the default phases of the multi-phase PWM controller 20 is less than or equal to the predetermined value, the process goes to step S3.

In step S2, the MCU 10 controls the multi-phase PWM controller 20 to change the default phases according to a predetermined order. For example, for first time change, the first to fourth phases are changed from default phases to non-default phase and the fifth to eighth phases are changed from non-default phases to default phases. For a second change, the fifth to eighth phases are changed from default phases to non-default phase and ninth to twelfth phases are changed from non-default phases to default phases. For a third change, the ninth to twelfth phases are changed from default phases to non-default phase and the first to fourth phases are changed from non-default phases to default phases. In the above changing order, the work time of all phases of the multi-phase PWM controller 20 is approximately equivalent over time, which can increase the life-span of the multi-phase PWM controller 20.

In step S3, the MCU 10 detects the work voltage level of the CPU 30.

In step S4, the MCU 10 determines whether the work voltage level of the CPU 30 is less than or equal to a first predetermined value, such as 387.0 milli-volts (mV). For this situation, the CPU 30 operates in a first work status. If the work voltage level of the CPU 30 is less than or equal to the first predetermined value, the process goes to step S5. If the work voltage level of the CPU 30 is greater than the first predetermined value, the process goes to step S6.

In step S5, the MCU 10 controls the multi-phase PWM controller 20 to provide four default phases to the CPU 30, and then the process goes back to step S3.

In step S6, the MCU 10 determines whether the work voltage level of the CPU 30 is greater than the first predetermined value and less than or equal to a second predetermined value, such as 518.30 mV. For this situation, the CPU 30 operates in a second work status. If the work voltage level of the CPU 30 is greater than the first predetermined value and less than or equal to the second predetermined value, the process goes to step S7. If the work voltage level of the CPU 30 is greater than the second predetermined value, the process goes to step S8.

In step S7, the MCU 10 controls the multi-phase PWM controller 20 to provide six phases including the four default phases and two non-default phases to the CPU 30, and then the process goes back to step S3.

In step S8, the MCU 10 determines whether the work voltage level of the CPU 30 is greater than the second predetermined value and less than or equal to a third predetermined value, such as 645.8 mV. For this situation, the CPU 30 will operate in a third work status. If the work voltage level of the CPU 30 is greater than the second predetermined value and less than or equal to the third predetermined value, the process goes to step S9. If the work voltage level of the CPU 30 is greater than the third predetermined value, the process goes to step S10.

In step S9, the MCU 10 controls the multi-phase PWM controller 20 to provide eight phases including the four default phases and four non-default phases to the CPU 30, and then the process goes back to step S3.

In step S10, the MCU 10 determines whether the work voltage level of the CPU 30 is greater than the third predetermined value and less than or equal to a fourth predetermined value, such as 780.24 mV. For this situation, the CPU 30 operates in a fourth work status. If the work voltage level of the CPU 30 is greater than the third predetermined value and less than or equal to the fourth predetermined value, the process goes to step S11. If the work voltage level of the CPU 30 is greater than the fourth predetermined value, the process goes to step S12.

In step S11, the MCU 10 controls the multi-phase PWM controller 20 to provide ten phases including the four default phases and six non-default phases to the CPU 30, and then the process goes back to step S3.

In step S12, the MCU 10 controls the multi-phase PWM controller 20 to provide twelve phases including the four default phases and eight non-default phases to the CPU 30, and then the process goes back to step S3.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A phase adjusting system comprising:
a controlled element;
a multi-phase pulse-width modulation (PWM) controller to provide phases to the controlled element, the PWM controller comprising a plurality of default phases and a plurality of non-default phases, wherein the plurality of default phases are output at all time in response to the PWM controller working; and
a microprogrammed control unit (MCU) connected to the controlled element via the multi-phase PWM controller, the MCU detecting the work voltage level of the controlled element and controlling the multi-phase PWM controller to provide a corresponding number of phases to the controlled element according to a detected work voltage level of the controlled element;
wherein the MCU determines whether work time of the plurality of default phases of the multi-phase PWM controller is greater than a predetermined value in response to the MCU being initialized, the plurality of default phases is changed to non-default phases and a corresponding number of the plurality of non-default phases are changed to default phases in response to the work time of the plurality of default phases of the multi-phase PWM controller being greater than the predetermined value.

2. The phase adjusting system of claim 1, wherein the controlled element is a central processing unit (CPU).

3. The phase adjusting system of claim 1, wherein the multi-phase PWM controller is a twelve-phase PWM controller comprising four default phases.

4. A phase adjusting method to control a multi-phase pulse-width modulation (PWM) controller to provide phases to a controlled element, the phase adjusting method comprising:
determining whether work time of default phases of the multi-phase PWM controller is greater than a predetermined value;
controlling the multi-phase PWM controller to change the default phases according to a predetermined order in response to the work time of default phases of the multi-phase PWM controller being greater than the predetermined value;
detecting a work voltage level of the controlled element in response to the work time of default phases of the multi-phase PWM controller being less than or equal to the predetermined value;
determining whether the work voltage level of the controlled element is less than or equal to a first predetermined value;
controlling the multi-phase PWM controller to provide the default phases to the controlled element in response to the work voltage level of the controlled element being less than or equal to the first predetermined value, and returning to the step of detecting a work voltage level of the controlled element; and
controlling the multi-phase PWM controller to provide the default phases and a corresponding number of non-default phases to the controlled element in response to the work voltage level of the controlled element being greater than the first predetermined value, and returning to the step of detecting a work voltage level of the controlled element.

5. The phase adjusting method of claim 4, wherein the multi-phase PWM controller is a twelve-phase PWM controller comprising four default phases.

6. The phase adjusting method of claim 5, wherein the step of controlling the multi-phase PWM controller to provide the default phases and a corresponding number of non-default phases to the controlled element, comprising:
determining whether the work voltage level of the controlled element is greater than the first predetermined value and less than or equal to a second predetermined value;
controlling the multi-phase PWM controller to provide six phases including the four default phases and two non-default phases to the controlled element in response to the work voltage level of the controlled element being greater than the first predetermined value and less than or equal to the second predetermined value, and then returning to the step of detecting a work voltage level of the controlled element;
determining whether the work voltage level of the controlled element is greater than the second predetermined value and less than or equal to a third predetermined value;
controlling the multi-phase PWM controller to provide eight phases including the four default phases and four non-default phases to the controlled element in response to the work voltage level of the controlled element being greater than the second predetermined value and less than or equal to the third predetermined value, and then returning to the step of detecting a work voltage level of the controlled element;
determining whether the work voltage level of the controlled element is greater than the third predetermined value and less than or equal to a fourth predetermined value;
controlling the multi-phase PWM controller to provide ten phases including the four default phases and six non-default phases to the controlled element in response to the work voltage level of the controlled element being greater than the third predetermined value and less than or equal to the fourth predetermined value, and then returning to the step of detecting a work voltage level of the controlled element; and
controlling the multi-phase PWM controller to provide twelve phases including the four default phases and eight non-default phases to the controlled element in response to the work voltage level of the controlled element being greater than the fourth predetermined value, and then returning to the step of detecting a work voltage level of the controlled element.

7. The phase adjusting method of claim 6, wherein the first to fourth predetermined values are 387.0 milli-volts (mV), 518.30 mV, 645.8 mV, and 780.24 mV, respectively.

8. The phase adjusting method of claim 4, wherein the controlled element is a central processing unit (CPU).
